(19) United States
(12) Patent Application Publication
(10) Pub. No.: US 2018/0225693 A1
(43) Pub. Date: Aug. 9, 2018

(54) CONSUMER DATA AND PRIVACY CONTROLS IN A SOCIAL NETWORKING ENVIRONMENT

(71) Applicant: Richard Postrel, Miami Beach, FL (US)

(72) Inventor: Richard Postrel, Miami Beach, FL (US)

(21) Appl. No.: 15/949,486

(22) Filed: Apr. 10, 2018

Related U.S. Application Data
(63) Continuation-in-part of application No. 14/788,985, filed on Jul. 1, 2015.
Application No. 14/788,985 is a continuation of application No. 13/413,416, filed on Mar. 6, 2012, now Pat. No. 9,105,043.
(60) Provisional application No. 62/508,034, filed on May 18, 2017.
(60) Provisional application No. 62/517,134, filed on Jun. 8, 2017.
(60) Provisional application No. 62/625,519, filed on Feb. 2, 2018.

(51) Int. Cl. G06Q 30/02; H04L 29/08; G06F 17/30; G06Q 50/00; H04L 29/06

(52) U.S. Cl. CPC G06Q 30/0214; H04L 67/306; H04L 67/22; H04L 67/20; H04L 63/102; G06Q 50/01; G06Q 30/0236; G06Q 30/0224; G06F 17/30867

(57) ABSTRACT

A method of and system for enabling users to manage and control access to and utilization of the data that is collected by web sites, social networks and the like regarding their online and offline interactions, and operating a rewards-based social network wherein rewards are issued by a third party to a member of the social network in exchange for providing access to that online interaction profile data of the member and their networked members, wherein the profile and/or rewards may be stored in one or more records in a blockchain ledger. The rewards may take the form of a cryptocurrency, cash currency, reward points and miles, store credits, bartered goods and services, micro-bits, and the like. Users can manage their profile, and accordingly the compensation they receive from third parties for access to their profile, through a dashboard interface accessible on the web.

### TECHNICAL FIELD

This invention relates to social networking commerce and rewards/incentives, and in particular to methods and systems for utilizing social networks to permissively collect and analyze data from their users/members, target and distribute advertising to and from members of social networks by providing incentives, rewards and other compensation, wherein each member maintains complete and detailed control over the access to and use of their private data. This invention also relates to the use of blockchain methodologies for awarding, tracking, aggregating, redeeming, monetizing, and managing the compensation and rewards that are provided in exchange for access to the members' private data.

More particularly, the present invention is related to providing compensation and rewards for access to data on actions taken by users who are members of one or more social networks. Payments in the form of micro-bits, aspirational and/or experiential rewards, reward points, frequent flyer miles, alternative currencies, goods and services, i.e. barter as well as other tangible and non-tangible benefits are earned, won or granted for access to the user's data. In each instance, a commercial relationship is established between the social network and the user whereupon the user is compensated for access to their profile information (data), which includes a record of online actions they take within the social network (e.g. sharing or liking something) as well as outside the network (e.g. web browsing). This changes the fundamental dynamics of the relationship between the social networks and the users, whereby issues regarding ownership and utilization of users' data and content, and users' privacy, are clearly defined by allowing the users to generate value through each and every action they take and have taken, to the degree that they allow. This results in the underpinnings of a sharing economy, in which users may share in revenue generated through the use of their data, which they may selectively share with third parties as desired.

### BACKGROUND OF THE INVENTION

In the prevalent online world, consumers generate an immense amount of data regarding their interaction with others, web browsing, ecommerce transactions, and the like. In particular, consumers' increased usage of social networks such as FACEBOOK or TWITTER in which members share images and videos, and have interactive chat sessions with messaging to select members of their social network, and other social and data networks, has caused an exponential increase in the amount of data available regarding their online activities. Social networking services that are currently implemented often gather information from their members in a surreptitious manner, whereby the members do not even know that their information is being used, or that their activities are being tracked, etc. Users of social networks (also referred to interchangeably as members) therefore have great value, which may vary as it pertains to different third parties such as marketers, advertisers, manufacturers and the like.

Members of social networks act in essentially three different roles as follows:
Member as a user
Member as a consumer
Member as an influencer

A member acts as a consumer when he executes online e-commerce transactions, such as purchasing goods and services over the internet. This includes shopping habits, and/or prior purchase transaction history. A member acts as an influencer when he interacts in his social network, e.g. posting, chatting, liking others' posts, etc. A member acts as a user when he takes actions over the internet that are not part of his consumer or influencer states. Typical examples of user action include web searching and browsing for informational purposes only (e.g. researching a topic for a school paper).

Therefore, members of social networks can monetize the value of each of these three states, as a function of the social network(s) that they belong to, in particular when the value of the members in his social network(s) is high then his value is high since he will be perceived as being able to provide access to those valuable members by a third party. Advertisers and other third parties have a great desire to access the data collected by social networks since that data indicates preferences for various products, services, interests, and the like. That is, since members of social networks often have common interests and socioeconomic status, it is desired to be able to utilize the vast amounts of information available from those members in order to market various products and services.

In additional but related problem is that this demand for access to the consumers' data has led to massive data breaches and misuse, whereby reports of consumer data theft are uncovered on a daily basis. Thus, consumers recognize that their data is being illicitly used by third parties, without their permission, thereby causing a consumer revolt.

It is therefore desired to address these issues of data privacy and control by consumers to give consumers complete control over the access to their data by third parties, and to compensate the consumers for granting such access. To do this, it is desired to provide members of social networks with incentives, rewards and other compensation for providing their information and allowing use of that information by third parties.

Information that is valuable to one marketer may be useless to another. It is therefore desired to target advertising to the desired market of users. It is also desired to advertise and market various products and services to these members using a viral methodology, and to compensate or reward the members for participating in the marketing efforts.

It is therefore also desired to collect data from members of social networks, which includes data regarding a primary member and other (secondary, tertiary and the like) members of their social networks, and analyze that data to provide more meaningful information to third party marketers as well as compensation to the members for use of their data, wherein the members have granular and defined control over the use of their data. Social network data collection and analysis implements a layered approach under this invention, wherein the members act as nodes and the data collection can travel deep into various social networks and sub-networks as may be permitted and desired.

Prior art incentive systems are typically implemented utilizing reward points and other types of purchase incentives (e.g. rebates, coupons, and the like). While reward points are quite useful if managed properly, many consumers desire payment incentives in the form of currency, which is fungible and interoperable with any payment system. That is, if a consumer is rewarded with reward points, he or she would be limited in their ability to redeem those points at various merchants; while payment in the form of a currency allows the consumer to spend that currency at any merchant. However, payment or reward in the form of currency is problematic and presents challenges that have not been addressed in the prior art.

Blockchain is a technology that enables anonymous and decentralized management of data in a reliable and secure manner. This provides many advantages, and in particular provides a means under the current invention described herein to address the deficiencies in the prior art as explained above. In particular, the use of a blockchain to award, track, aggregate, segment, and redeem rewards (referred to herein as micro-bits) under this invention provides advantages not available in prior art reward systems.

### SUMMARY OF THE INVENTION

Provided is method of and system for enabling users to manage and control access to and utilization of the data that is collected by web sites, social networks and the like regarding their online and offline interactions, and operating a rewards-based social network wherein rewards are issued by a third party to a member of the social network in exchange for providing access to that online interaction profile data of the member and their networked members, wherein the profile and/or rewards may be stored in one or more records in a blockchain ledger. The rewards may take the form of a virtual currency, cryptocurrency, cash currency, reward points and miles, store credits, bartered goods and services, micro-bits, and the like. Users can manage their profile data, and accordingly the compensation they receive from third parties for access to their profile data, through a dashboard interface provided by the social network service and accessible on the web.

In particular, provided is a method of and system for controlled access to a user profile of a user/member of a social network. A user profile comprising data associated with a user, such as contact information, age, demographics, income level, contact information of friends and other members of their social network, and the like, is stored in a computer memory. The computer-based activities of the user (such as social network interactions, online purchase transactions, and/or web browsing activities) are then monitored throughout a defined period of time, for example a 24-hour period. The user profile is continuously and dynamically updated in real-time throughout this period to include each monitored computer-based activity of the user as it occurs. For each instance of updating the user profile, a user profile score is calculated in real-time as a function of the updated user profile. The user profile score (but not the underlying user profile data itself) is continuously provided to one or more third parties, and in particular, access to the underlying user's profile data is offered to the third parties only in exchange for compensation to the user. If any of those third parties is interested in accessing the underlying user profile data based on viewing just the profile score, then that third party may be given limited or complete access to the profile data in exchange for providing compensation to the user, only when the user grants permission for the third party to access the user profile. Optionally, the user profile may be stored in a blockchain ledger, and the user profile is updated by recording the monitored computer-based activity to a record in the blockchain ledger.

In another embodiment, the user is a member of a social network comprising a plurality of members, with each member having their own user profile and profile score stored in a computer memory that is updated for each computer-based activity they execute. Here, a network score is calculated as a function of the user profile scores of each member and then provided to a third party. Access to the network profile and to each of the member's user profile is offered to the third party in exchange for compensation to the members of the social network, only when the members each grant permission for the third party to access the member's user profile.

Notably, the user profile score may vary as a function of a field of use. That is, a user profile may have a high score with respect to one type of advertiser's field of use, yet have a low score with respect to another type of advertiser's field of use. For example, a young male user may be more valuable to a sports car manufacturer and have a high score for that entity, yet be less valuable to a dress manufacturer and thus have a low score for that entity.

The compensation provided to the user in exchange for access to his user profile data may include rewards such as aspirational/experiential rewards, virtual currency, cryptocurrency, cash currency, reward points and miles, store credits, bartered goods and services, micro-bits, and the like, that are recorded in the blockchain ledger. Rewards/compensation may be targeted towards the particular user profile of a particular member of the social network, thus increasing their engagement with the system and likelihood that they will participate. For example, if a member's profile indicates that he is a baseball fan, he may be provided with an aspirational/experiential reward that includes attendance at a luncheon at which a professional baseball player is a keynote speaker, and the like. This may be extended to an analysis of the network profile of a particular user, in which other members of his network are provided with a similar type of aspirational/experiential reward.

Optionally, the user may be able to view and manage their profile data and profile score through a dashboard interface accessible on the web. By viewing the changes to the profile and the resulting score as they execute various interactions on the web, the user can control how the score varies as a function of their web activity and the resulting profile data. This can help the user optimize his web interactions in order to obtain greater compensation from third parties. This dashboard may also be used to enable the user to interact directly with third parties and see offers for their profile data, and accept/counteroffer/reject such offers through the dashboard. The dashboard may also be used to report back to the user how his data is being used in the marketplace.

### BRIEF DESCRIPTION OF THE DRAWING

FIG. 1 is a block diagram of a preferred embodiment of the invention.

FIG. 2 is a flowchart of the operation of an embodiment of the invention.

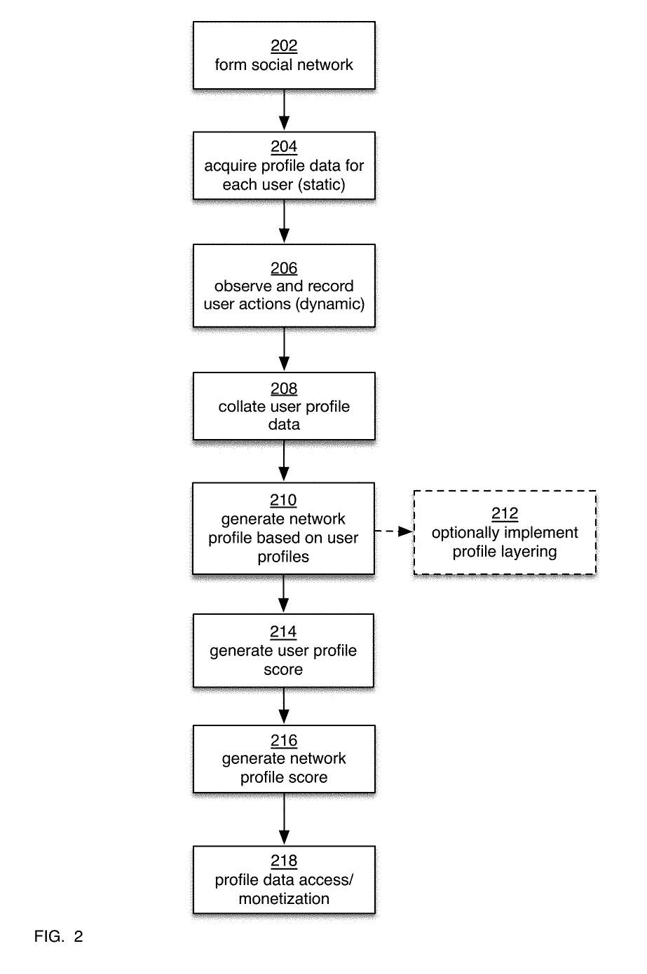

FIG. 3 is a flowchart showing influencer/follower levels utilized in the present invention.

FIG. 4 is an exemplary web page used for communication and control with the influencers of this invention.

FIG. 5 is a flowchart of the operation of an embodiment of the invention.

FIG. 6 is an exemplary web page of a user profile dashboard.

### DESCRIPTION OF THE PREFERRED EMBODIMENTS

The following main topics are now discussed in detail:
Social Networking Background
User Profiles
Network Profiles
Network Profile Layering
User Profile Scores
Network Profile Scores
Influencer-Follower Relationships
Blockchain Utilization

### Social Networking Background

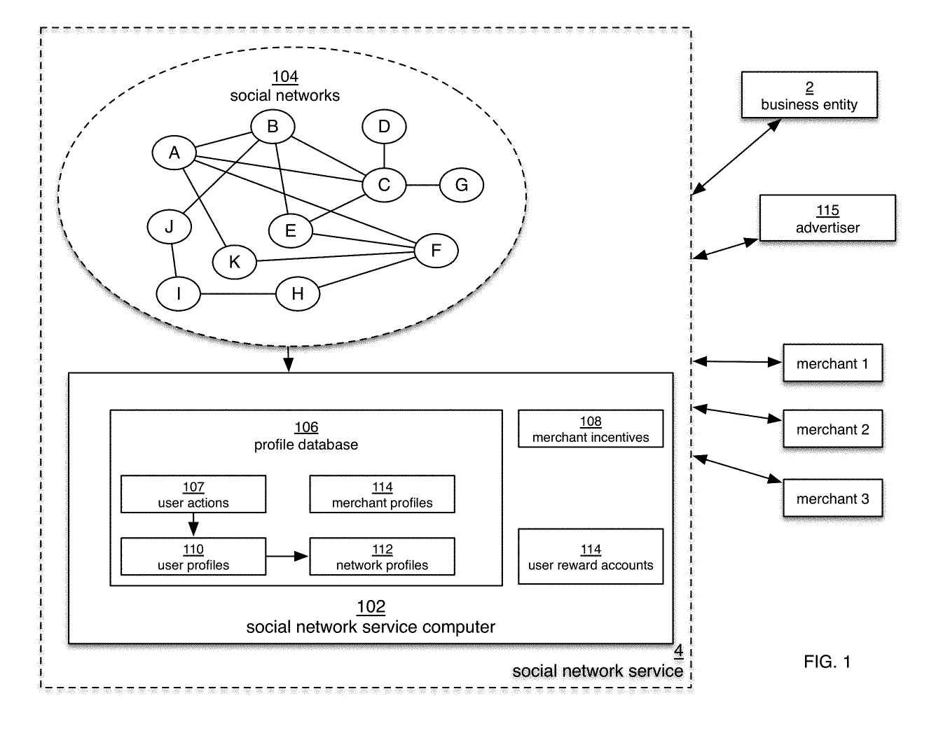

By way of background, FIG. 1 is a block diagram illustrating the general structure of a social networking service 4 utilized with the present invention. Interrelated social networks 104 are shown with various users referred to as members A, B, C, D, E, F, G, H, I, J and K. Only eleven members are shown here for illustrative purposes, although it is contemplated that the number of members that may be part of the social networks 104 is essentially unlimited. Social networks are constructs as well known the art that provide a communication paradigm amongst its various members. Social networks are groups of persons that interact with each other in some format(s), typically over an electronic communications network such as the Internet. Various social networking services exist, which facilitate interactions amongst the various constituent members that form the social networks. Examples of well-known existing social networking services include FACEBOOK, TWITTER, MYSPACE, AND GOOGLE+. These services enable its members to define various social networks in which the members choose to link with (or friend) each other to share information, images, videos, emails, chat, etc. The viral marketing engine described herein piggybacks on the infrastructure of these types of social networks. In this illustrative example, the members A, B, C, D, E, F, G, H, I, J and K shown within the dotted oval of FIG. 1 are all registered with the same social network server computer 102 but form different social networks as follows:

social network A: A-B-C-F-K
social network B: B-A-J-E-C
social network C: C-A-B-D-G-E
social network D: D-C
social network E: E-B-C-F
social network F: F-A-E-K-H
social network G: G-C
social network H: H-F-I
social network I: I-J-H
social network J: J-B-I
social network K: K-A-F

That is, member A has linked to members B, C, F and K to form the social network A. Similarly, member B has linked to members A, J, E and C to form the social network B, and so forth. Any information that A chooses to share in his social network A will be received by B, C, F and K. Similarly, any information that B chooses to share in his social network B will be received by A, J, E and C, and so forth. Member A is considered to be the primary member of social network A since he is the common link. Similarly, member B is considered to be the primary member of the social network B since he is the common link. Any member of a social network who is not the primary member of that social network is considered to be a secondary member of that network. Each member of the social networking service will be a primary member to one social network (defined by the secondary members to whom he has linked), and each member is a secondary member to the social networks of those in his social network. Thus, member A is a secondary member to social networks B, C, F and K. Even though E is linked to B, E will not receive information received by B from A since E is not linked to A directly. The term social network 104 is used herein to refer to any of the social networks as described above.

Referring to the flowchart of FIG. 1, at step 202 the social network 104 may be formed amongst its various members utilizing the social network server computer 102 which runs the social networking service 4. The members of the social network 104 communicate with the social network server computer 102 by using various user computers (not shown), which may be desktop computers, laptop computers, tablets, smartphones, etc. These user computers communicate with the social network server computer 102 through a wired and/or wireless communications network(s) such as the internet. Typically, each member will register or enroll with the social network server computer 102 and indicate their desire to join a particular social network 104 by linking with at least one of the constituent members of that social network. Any member may invite any other member to join his network, for example by an email message as known in the art. For example, member A has requested members B, C, F and K to link to him, which they have all accepted. Non-members may join the network if desired based on parameters established by the social networking service. As the various members register with the social network server computer 102 and then link with each other, they will be able to interact with each other in various ways, including but not limited to the advertising and marketing interactions that will be described herein. In addition, members may invite other members of the social networking service, as well as non-members of the service, by issuing a broadcast invitation to groups of member and/or non-members as desired. This may occur over any type of medium, including but not limited to television or radio broadcasts, mass mail and email, etc. Invitees may accept the invitation to join the member's social network and register with the network. Formation of social networks utilizing social network server computers and services is well known in the art.

### User Profiles

At step 204, each member of the social network will provide their personal information and data to the social network server computer 102 for inclusion in a user profile 110 that will be stored in the profile database 106 as shown in FIG. 1. The user profile 110 will include various pieces of information that are associated with the member, including but not limited to personal information of the member such as income, age, location, and occupation. Additionally, the user profile 110 may include a listing of the reward/loyalty/incentive programs with which the member is registered. These data types are referred to as static data types since the data generally will not vary over time.

At step 206, a user dynamic data is observed and recorded. Dynamic data is that data that will continuously varies over time. In this embodiment, the member's user profile is considered to be three-dimensional in that it takes on three separate but related components, based on the current active state of the member:
Member as a user
Member as a consumer
Member as in influencer

A member acts as a consumer when he executes online e-commerce transactions, such as purchasing goods and services over the internet. This includes shopping habits, and/or prior purchase transaction history. A member acts as an influencer when he interacts in his social network, e.g. posting, chatting, liking others' posts, etc. A member acts as a user when he takes actions over the internet that are not part of his consumer or influencer states. Typical examples of user action include web searching and browsing for informational purposes only (e.g. researching a topic for a school paper). Member actions are stored in the profile database 106 at block 107.

In each of these three states, the member is graded on his actions under that state, and a profile score is assigned to the member by an algorithm executing on the social network computer (discussed further below). This paradigm gives a true meaningful value and measurement tool for the usefulness, meaningfulness and results of any particular campaign or data set.

In addition, various profile components related to a member are analyzed based on the following dynamic components:
Economic component
Geocentric component
Predictive component based on social and behavioral components
Routine component that identifies patterns.

At step 208, the static profile data and the dynamic profile data are collated into the user profile. As such, the member's user profile will continuously and dynamically shift in real-time depending on this changing data. That is, the member's user profile will vary (as well as his profile score) based on where the member is during the day, what they are doing, how they are interacting over the internet, etc. This is quite different from prior art profiling which is essentially static and does not change over time. By viewing the user as having a continuously and dynamically changing profile, and related profile score, the third parties gaining access to these members are given a much more accurate and meaningful picture of the members. User profiles may also include a score that indicates the member's relative value to a third party marketer interested in gaining access to that member, as discussed further herein.

Any user that has been designated as a minor will be subject to COPA compliance (and/or any other similar mandate) under the embodiments of the invention.

### Network Profiles

In addition to individual user profiles, each member will also have a network profile. At step 210, a member's network profile 112 is generated based on an analysis of the constituent user profiles 110 (i.e. the primary member and all secondary members of that social network), and is stored in the profile database 106. The network profile is intended to be reflective of the information found in each of the constituent user profiles, and will subsequently be used in order to generate merchant incentives 108 and other rewards and compensation. The network profile 112 may be generated in one or more of various manners discussed further below.

Thus, the social network server computer 102 will generate network profile A for social network A, which will be based on the user profiles for primary member A and secondary members B, C, F and K. Similarly, the social network server computer 102 will generate network profile B for social network B, which will be based on the user profiles for primary member B and secondary members A, J, E, and C, and so forth. The term network profile 112 is used herein to refer to any of the network profiles as described above. As such, each member will have an associated network profile 112 that is based on the individual user profiles of the secondary members in his own social network for which he is the primary member.

In one embodiment, the network profile 112 may reflect an average profile of all of the constituent user profiles (i.e. the primary members and all secondary members). Averages may easily be generated for numerical data types; for example, the network profile may contain the average member age, the average income level, average household size, average number of years married, average height, average weight, average family size, etc. Data types that are not numerical may be analyzed to provide a quasi-average indication as well. For example, if most members live in the northeast region of the United States but a few live in the south region, then the network profile for those members may simply indicate that the average member lives in the northeast region.

Additionally (or in the alternative), the network profile 112 may reflect an aggregate profile of all of the constituent user profiles. For example, the network profile may indicate that 55% of the members are male and 45% are female, or it may indicate that 65% are adults and 35% are teenagers, or it may indicate that 4,657 of the 5,550 members graduated from college and the rest did not, or it may indicate that approximately half the members live inside the United States and half live outside the United States, etc.

Additionally (or in the alternative), the network profile 112 may reflect a comparison of its constituent members with non-members of that social network. For example, the network profile A for social network A may indicate that 80% of its constituent members A, B, C, F and K work in the professional services industry compared to only 16% of the non-members of social network A (D, E, G, H, I, J, and/or non-members of the social networking service).

In the embodiments wherein the members' profile contain constantly-varying dynamic data as described above, the network profiles that are calculated as a function of those user profiles will likewise constantly vary.

Other mechanisms for generating a network profile that is in some way representative of some or all of the constituent user profiles are also contemplated by this invention.

### Network Profile Layering

As described above, a secondary member may provide his individual user profile for use when a network profile is generated for any social network of which he is a member. In the alternative, at step 212 the secondary member may allow use of his network profile rather than (or in addition to) his individual user profile. By providing access to his network profile, a better analysis of that secondary member is obtained.

For example, member A as described above is the primary member of social network A, and the network profile for his network A is determined as

NP_{A}=f(P_{A}+P_{B}+P_{C}+P_{F}+P_{K})

wherein NP_{A} is the network profile of member A
P_{A} is the individual profile of member A
P_{B} is the individual profile of member B
P_{C} is the individual profile of member C
P_{F} is the individual profile of member F
P_{K} is the individual profile of member K

In this alternative embodiment, any or all of the individual user profiles of the secondary members A, B, C, F, or K may be substituted with that member's network profile. For example, member B as described above is the primary member of social network B, and the network profile for his network B is determined as

NP_{B}=f(P_{B}+P_{A}+P_{J}+P_{E}+P_{C})

wherein NP_{B} is the network profile of member B
P_{B} is the individual user profile of member B
P_{A} is the individual user profile of member A
P_{J} is the individual user profile of member J
P_{E} is the individual user profile of member E
P_{C} is the individual user profile of member C

So, substituting NP_{B} for P_{B} into the determination of NP_{A} provides:

NP_{A}=f(P_{A}+f(P_{B}+P_{A}+P_{J}+P_{E}+P_{C})+P_{C}+P_{F}+P_{K})

This may be further extended to the network profile of secondary member C of social network A as follows:

NP_{A}=f(P_{A}+f(P_{B}+P_{A}+P_{J}+P_{E}+P_{C})+f(P_{C}+P_{A}+P_{B}+P_{D}+P_{G}+P_{E})+P_{F}+P_{K})

This may extended so that all individual user profiles are substituted with their corresponding network profiles as follows:

NP_{A}=f(P_{A}+f(P_{B}+P_{A}+P_{J}+P_{E}+P_{C})+f(P_{C}+P_{A}+P_{B}+P_{D}+P_{G}+P_{E})+f(P_{F}+P_{A}+P_{E}+P_{K}+P_{H})+f(P_{K}+P_{A}+P_{F})

The result of using the network profiles of the secondary members B, C, F and K rather than the individual user profiles of the secondary members is a more robust and detailed network profile for primary member A.

This layered approach may be extended down another level as desired. For example, one may substitute the network profile for member C as follows:

NP_{A}=f(P_{A}+f(P_{B}+P_{A}+P_{J}+P_{E}+f(P_{C}+P_{A}+P_{B}+P_{D}+P_{G}+P_{E}))+f(f(P_{C}+P_{A}+P_{B}+P_{D}+P_{G}+P_{E})+P_{A}+P_{B}+P_{D}+P_{G}+P_{E})+f(P_{F}+P_{A}+P_{E}+P_{K}+P_{H})+f(P_{K}+P_{A}+P_{F})

This may extended as many layers as may be desired.

### User Profile Scores

At step 214, a user profile score is then calculated as a function of a member's user profile. That is, each member of a social network will have his own individual user profile score that is a function of his user profile. The score may be generated and then accessed by a third party to see if that third party is interested in accessing the user data underlying the user profile score. In addition, a network score is calculated at step 216 as a function of a member's network profile. As with the user profile score, the network score may be accessed by a third party to see if that third party is interested in accessing the underlying network profile data for that member's network. User profile scores and network profile scores are described in further detail below.

### Network Profile Scores

Under this invention, a member has value, and can monetize that value, as a function of the social network(s) that he belongs to, in particular when the value of the members in his social network(s) is high then his value is high since he will be perceived as being able to provide access to those valuable members by a third party. A network score can be calculated and assigned to each member as a function of their network profile. That network score would then be relatively higher when a member's social network has a high network profile. For example, if member B has a high value, then everyone that is networked with B will have a relatively higher value since member B adds to their score.

At step 218, the third party may access the member's user profile data and/or his network profile data, if permission is granted and in exchange for compensation to the member and/or his network members.

In an alternative embodiment, members that have similar user profile scores may be grouped or aggregated together in an ad hoc manner for a particular campaign. That is, temporary networks may be formed of similar members having similar user profiles and profile scores even if those members are not already in each other's social networks, so that third parties can reach those with common profiles/interests on common ground.

A value quotient may be generated that indicates the meaningfulness in mathematical terms of the relationship between the primary user in each of his or her secondary relationships.

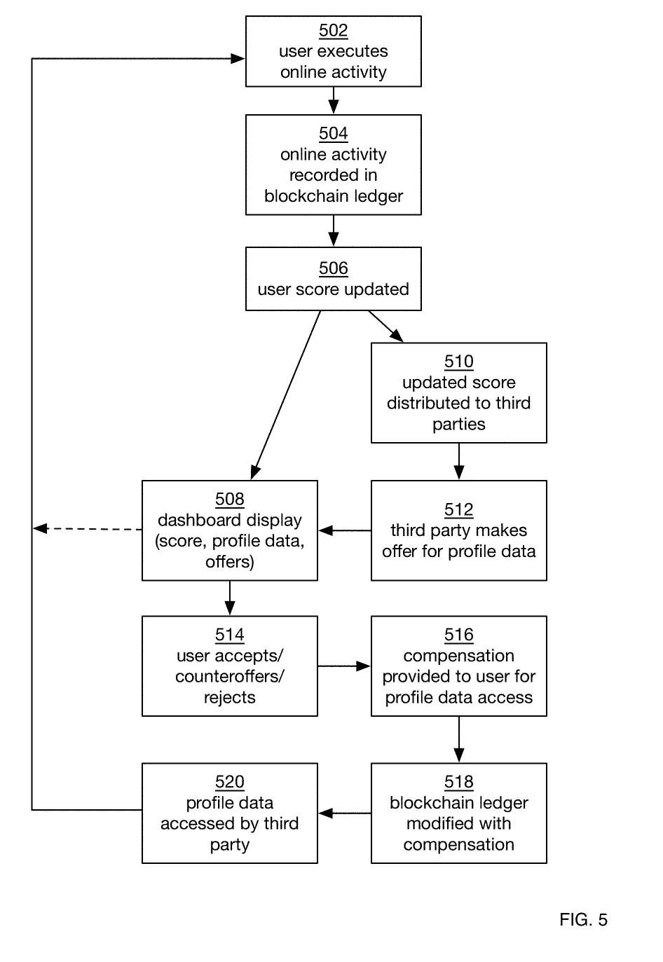

Reference is now made to the flowchart of FIG. 5. At step 502, the user executes an online computer-based activity, which includes those that are executed via the internet, and may include but is not limited to a web search and browsing session, an e-commerce transaction such as with EBAY or AMAZON, video viewing via YOUTUBE, and the like. Online activities may also include interactions with the user's social network(s) such as FACEBOOK and TWITTER, including posting, tweeting, messaging, friending, liking, etc.

At step 504, the online activity is recorded in the user profile at the social network server computer, which in some embodiments would be logged as a record in the blockchain ledger stored at the social network service computer. That is, each online activity appears as a separate record that may be tracked and analyzed. As explained further below, the user may be able to control which activities are recorded in the profile through a user profile dashboard or other profile management tool.

While this embodiment focuses on online activities that are recorded at the social network computer, offline activities may be recorded as well. Offline activities are those that are conducted solely on the user's own computer wherein data is not transferred in real time via the internet, and may include but is not limited to document generation and editing, photograph management, etc. In this alternative embodiment, the offline activities may recorded in the user's profile in real time if the user computer is interconnected to the internet. If however the user's computer is offline, then those activities are logged locally on the user's computer and then uploaded to the social network server computer and stored into the user profile in the blockchain ledger when the user subsequently goes online.

After a new online activity is recorded in the user profile, the user profile score is immediately updated at step 506. The user profile score is based on an algorithmic analysis by the social network computer of the information in the user profile blockchain ledger. That is, all of the profile information is analyzed in real time as it is recorded in the blockchain, and the profile score is re-calculated accordingly. The user profile score is an overall indication of the value of the profile data to a third party such as an advertiser, distributor, manufacturer, etc. The user profile score is intended to give the third party an indication as to how valuable the user may be to that third party, in particular how valuable his profile data may be to that third party, without actually revealing the profile data itself until authorized by the user. The user profile score may be biased towards a particular field of use that would be of interest to certain third parties and not of interest to other third parties. For example, users whose data shows an interest in purchasing an automobile (e.g. web searches for new automobiles, pricing calculations for financing, posting social media inquiries about new automobiles, etc.) would yield a higher score with respect to automobile manufacturers and advertisers, but a lower score with respect to clothing distributors. This indicates to the automobile manufacturer that this user is interested in purchasing an automobile, and the automobile manufacturer would likely pay a higher rate of compensation to see the profile data of that user as indicated in his profile score. The result of this is that the user profile score may be different in different fields of use (interest), reflective of the particular audience that is viewing the profile score.

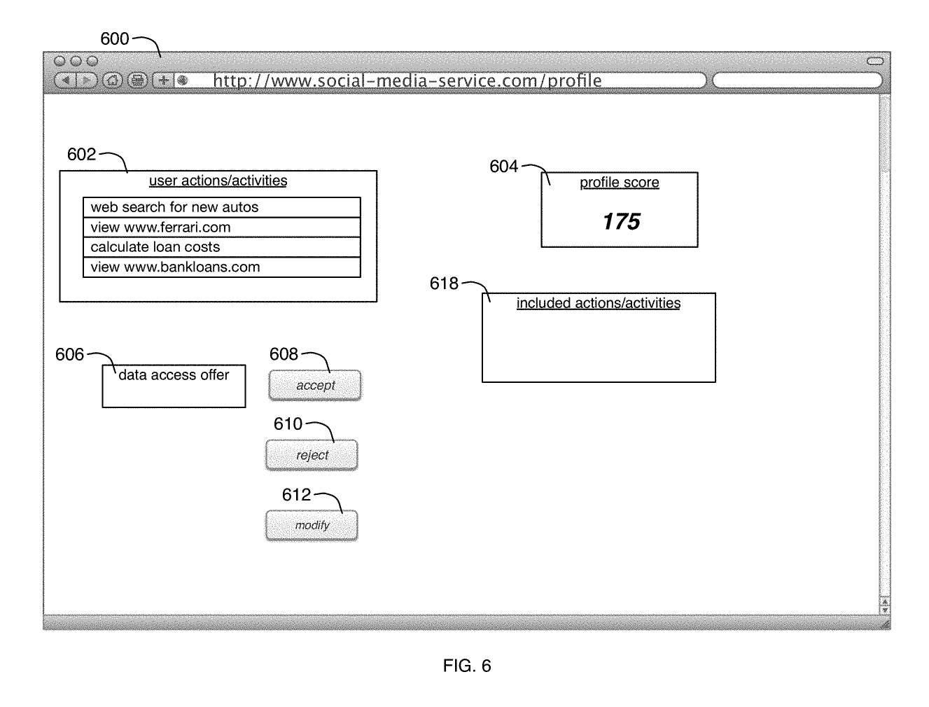

After the profile score is updated at step 506, then a user profile dashboard display is updated at step 508 to reflect the newly updated profile score and/or the additional profile data and user activity as it occurs in real time. FIG. 6 illustrates an example of a user profile dashboard that may be implemented in this embodiment. Via the dashboard, a member may control how his user profile data is used via a set of privacy options and controls presented to the member. The member may allow his profile to be used in calculating the network profile of any network of which he is a direct member (as a secondary member). Similarly, the member may allow his profile to be used in calculating the network profile of any member that he may be linked to, directly as a secondary member or indirectly, etc. Similarly, he may control how his profile data is used, which merchants may be granted access to his data, etc.

Interactive web page 600 is served by the social network server computer to the user's computer for display thereon. The web page 600 includes a list of user activities 602, which is shown for example as a web search for new automobiles, then a viewing of the web page www.ferrari.com, then a calculation of the costs for a loan for an automobile, then a viewing of the website www.bankloans.com, etc. As each of these activities is executed by the user at his computer at step 502, it is recorded in the blockchain at step 504, and the user's score is updated at step 506 and displayed on the dashboard page in box 604 at step 508. Also, the activity that has been recorded and used to update the score is also displayed inbox 602. Thus, the user is able to see, in real-time, how the activity he has performed has changed his profile score in box 604. This may be shown in his computer display as a small window in the corner of his display simultaneous with the activity he is currently performing. As explained above, a user may have several profile scores that are each biased towards a particular field of use. In this embodiment, there would be several score display boxes 604, and each would be labelled with the field of use bias for that score.

At step 510, the updated user profile score is provided by the social network service computer to one or more third parties who may be interested in accessing the underlying profile data. At step 512, a third party can make an offer to the user for accessing the profile data of the user based on analysis of the user profile score. For example, the third party may offer the user $3 to access his profile data. This offer is communicated to the user via the social network computer, which displays the offer(s) in box 606 at step 508. This process of steps 502-512 may continue via the dashed line of the flowchart in FIG. 8 continuously, in real-time, as the user executes online activities throughout his computer usage period (e.g. throughout the day).

At some point, the user may desire to accept, reject, or counteroffer the offer made by the third party at step 514. In the simple case of the user accepting the third party offer, he can select the accept button 608 on the dashboard. This acceptance is communicated through the social network server computer back to the third party, which will convey the agreed-to compensation to the user, typically by requesting the social network server computer to make the appropriate entry in the blockchain ledger at step 516. The blockchain ledger is modified with the compensation at step 518, and the social network server computer releases the user profile data to the third party at step 520. The user may, in the alternative to accepting the offer, choose to make a counteroffer by selecting button 612, or he may outright reject the offer by selecting button 610.

The profile data may exist in the form of a text file, spreadsheet, list of database entries, etc. When the third party is granted access to that profile data in exchange for compensation to the user, the file is made available to the third party for online viewing, downloading, storing, and the like, depending on a level of access that is granted by the user to the third party. This is controlled via the web page 600. Thus, a user may grant only viewing access to the third party in exchange for one level of compensation, but may allow the third party to download the file and save it for more compensation. Also, the user may filter out certain data from access by the third party, based on the compensation agreed to.

The user may be able to control which activities are recorded in the profile and made available to third parties through the dashboard or other profile management tool. For example, the user may specify that only online activities may be recorded, or he may specify that only social networking activities may be recorded, etc. Box 618 on web page 600 shows the included activities as designated by the user, which may be managed by user interface controls as known in the art.

In addition to monetizing his user profile as described above, a user may seek to be compensated for use of his network profile. After the network profile 112 has been generated, it is analyzed in order to be able to determine the value of the constituent members of the social network in the aggregate to a merchant who participates in the program. As shown in FIG. 1, this network profile analysis is performed by the social network server computer 102.

The network profile 112 is analyzed by the social network server computer 102 in order to determine the constituent members' value to the merchant(s) and generate merchant incentives for distribution to the members of the social network. That is, by analyzing the properties of a network profile (and thus the properties of the associated social network), incentives may be generated that will drive traffic to the participating merchants in a meaningful way. In addition to targeting each individual network member this invention allows marketing to the social network members in the aggregate. Since members of the social network 104 share common interests that are defined by the social network itself, this leads to an intelligent incentive generation hereto unattainable in the prior art. This also provides an incentive for the members of that social network to provide their data in their profiles and to allow usage of their data. For example, a network profile may indicate that members of the associated social network have an average age of 27 years old and are generally interested in photography. This intelligence may be used by the merchants to generate an appropriate merchant incentive such as a coupon for a discounted camera lens. If a given member of this social network has not previously indicated in his user profile an interest in photography but has interests related to photography such that he has joined this social network for other reasons (e.g. an interest in art), this member will receive the lens coupon by virtue of his membership in the social network. Without this methodology, this member would not have been targeted for this incentive since he has not shown an interest in photography, but his membership in the social network for other closely related reasons enables him to receive the incentive. That is, this member has value to the merchant that sells the lens because of his association with the social network 104. This is just an example as to how this information may be utilized.

The merchant incentives that are generated as a function of the user profiles are distributed by the social network server computer 102 to the members of the social network 102. This may be done in various ways, including electronic downloads, email, text message, etc. The social network members may then use them at the various merchants as desired. In the methodology described above, all constituent members of a social network (i.e. the primary member and all secondary members) would receive the merchant incentives that are generated by the social network server computer 102 for that social network. For example, merchant incentives that are generated for social network A (by using the network profile A) would be distributed to all members of social network A (i.e. A, B, C, F, and K). A corollary to this is that member A would receive merchant incentives that are generated using network profiles A, B, C, F and K, since he is a primary member of social network A and a secondary member of social networks B, C, F and K (since he is linked to those members). In another embodiment, merchant incentives that are generated based on a given social network will only be distributed to the primary member of that social network. Thus, merchant incentives generated based on network profile A would be distributed only to primary member A, merchant incentives generated based on network profile B would be distributed only to primary member B, and so forth. In one example, the merchant incentive may increase in value as the number of secondary members of a given social network increases. This benefits the merchant since it can collect data from many more members. This provides an incentive for members to invite many other members to join his social network since it would result in incentives having an increased value. Optionally, a merchant profile(s) 114 may be used by the social network server computer 102 in addition to the network profile 112 in order to generate the merchant incentives 108. The merchant profiles 114 are associated with the various participating merchants and contain information about the merchant that may be useful in generating the merchant incentives. The merchant profiles may 114 for example contain guidelines and instructions to be used by the social network server computer 102, such as an instruction to generate incentives when the network profile indicates a certain age demographic, or income level, etc. As such, the merchants have a level of control over the incentive generation process carried out by the social network server computer 102.

In another embodiment of this invention, members of a social network may be compensated for use of their data based upon parameters of the social network as provided through the network profile. As the network profile is generated, that information (and/or the information from the constituent user profiles) may be provided to third party services such that revenue is generated and received by the social networking service as consideration for use of that information. This would be done after being given permission by the members for use of their information, whether individually (use by a third party of their own user profile) or in the aggregate (use by the third party of their information in the network profile). The member would then share in the compensation revenue received by the social networking service from the third party. In one case, revenue may be shared with only the primary member of the social network for use of the information from all of the members of his social network. In another case, revenue may be shared with the primary member of the social network and the secondary members of his social network for use of the information from all of the members of his social network. Third parties that may obtain member information from the various social networks via the social network server computer include merchants, rewards issuers, payment processors, and the like. Each of these third parties may have different uses for the information, but all would desire this information and as a result are willing to provide compensation to the member(s) for use of that information.

### Influencer-Follower Relationships

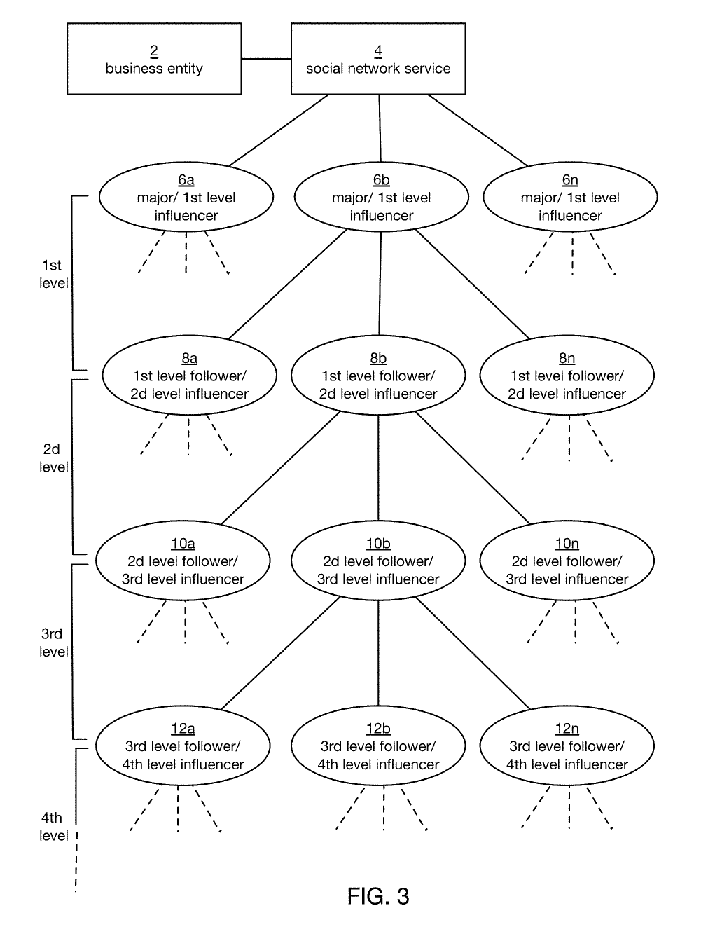

Referring now to an embodiment that utilizes a viral advertising and marketing engine, reference is made to FIG. 3. In FIG. 3, the business entity 2 may for example be a car manufacturer that interoperates with the social network service 4 using the following illustrative non-limiting example. The car manufacturer 2 desires to provide consumers with a certain number of test drives of a new vehicle in a certain period of time (e.g. one million test drives in six months). A target profile is generated that would match to their target customer, for example age between 21-45 years old, income level between $25K-$100K, etc. The social network service 4 then analyzes the target profile against the user profiles 110 and/or the network profiles 112 to generate a social graph, which matches user profiles to the target profile in various data points.

From the social graph, the social network service 4 will determine which of the members may be considered to be major influencers of the desired target customer(s)(e.g. celebrities such as a basketball star, a musical performer, an actor, etc.). These major influencers 6a, 6b, . . . 6n (referred to generally as major influencer 6) are shown in FIG. 3 at the top of the chart. For example, at the top or first level there may be twenty major influencers (n=20) that match the profile of the target customer from different touchpoints of that profile. The major influencers 6 are also referred to as first level influencers since they operate at this top or first level.

Each major influencer 6 would receive payment (e.g. $1M) for pitching the company 2 and its product, wherein each pitch is tailored by that major influencer 6 to appeal to their followers. In FIG. 3, major influencer 6b is shown having first level followers 8a, 8b, . . . 8n (referred to generally as first level follower 8). Their pitch would include an offer to their first level followers 8 that the follower that provides the most responses (in the form of test drives made by them or secondary members of their social network, in this case) gets a special reward (e.g. an expense-paid trip to visit the major influencer 6 at a certain date). Each major influencer's approach is likely to be different from the others since they appeal to different audiences. Notably, each follower will react stronger to a pitch from the influencer than they would otherwise would have from a general marketing campaign from the company as in the prior art.

As such, this takes a layered approach, with each first level follower 8 becoming a second level influencer to their own (second-level) followers (e.g. 10a, 10b, . . . 10n) who are in their social networks, and each second level follower 10 becoming a third level influencer to their own (third-level) followers (12a, 12b, . . . 12n) who are in their social networks, and so on. This is a nodal/network approach.

In this example, the major influencer 6 is the only party receiving direct payment from the car manufacturer 2, and the rewards that he/she provides to his/her (first level) followers 8 has a cash value component (e.g. the expense-paid trip to visit the major influencer) as well as an intangible aspirational component (the ability to spend time with the major influencer 6). At the second level, the reward provided by first level follower/second-level influencer 8 to the second level followers 10 likely will consist only of an aspirational reward component, and an aspirational reward component may flow down through the various levels as shown in FIG. 3. In addition to the aspirational reward component, followers at any level may also be provided with reward points that can be stored in their account in a reward database 114 at the social network service 4. These reward points can accumulate and may carry forward to other promotions as well. They may be funded by the major influencer (or business entity 2) as part of the economic reward in what is referred to as a bifurcated economic model, which includes an economic reward (cash and/or reward points) and an intangible aspirational reward. Reward points earned by the members for their participation in this program may be used in various subsequent programs, such as a new offering from the company (and/or a different company), a new offering from the influencer of that follower, or a new offering directly from the social network. This is referred to as a carry-forward model and is made possible by the universal applicability of the reward points across these various parties within the social network construct. Reward points may be combined from different programs and redeemed for economic prizes (e.g. a toaster) as well as non-economic aspirational prizes (e.g. a telephone call from a major influencer, autograph, etc).

Further details of this embodiment are now provided. At the first level, communications between the business entity 2 (optionally via the social network service 4) may be an interactive session in which an initial offer is communicated to the major influencer 6 via an email message, text message, or the like. The initial offer will contain the basic terms of the offering, and may direct the major influencer 6 to a web page in which a dashboard displaying terms of the offer are presented, and in which some or all of those terms may be accepted, modified, or rejected, thus giving the major influencer 6 a desired amount of user control over the process.

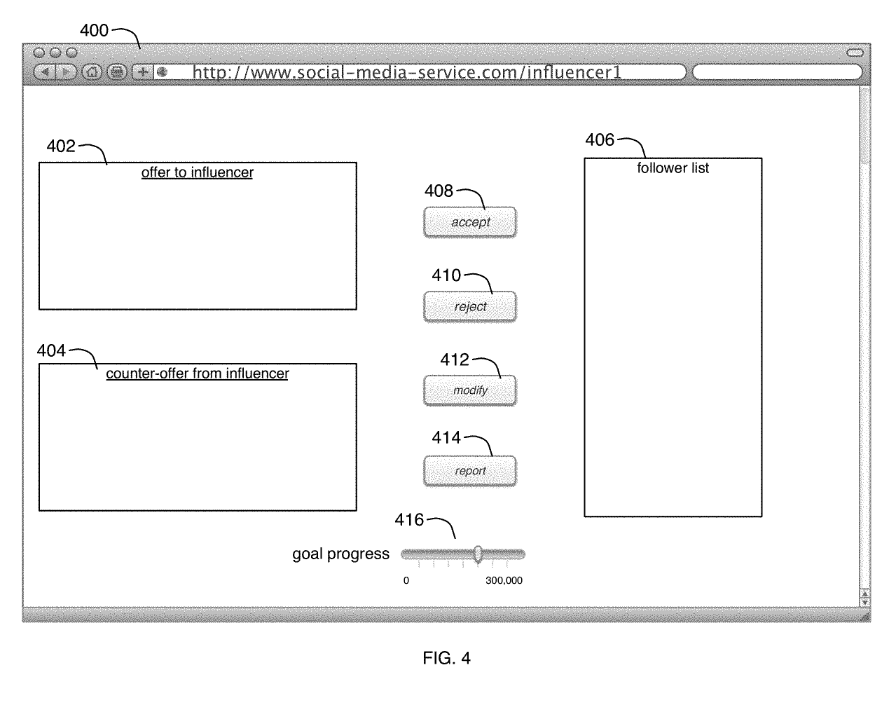

FIG. 4 illustrates a typical non-limiting example of a dashboard interface web page 400 that would be utilized by the major influencer 6 in interacting with the business entity 2 or social network service for this embodiment. This may include an offer box 402, which sets forth details of the offer made to the influencer; a counter-offer box 404, which sets forth details of a counter-offer made by the influencer; and series of control buttons including offer accept button 408, offer reject button 410, offer modify button 412, and report button 414. Also shown is a follower list box 406 and a progress bar 416.

The offer box 402 sets forth details of the offer made to the influencer as explained above, and is provided by the business entity that is providing the marketing program, this is provided either directly by the business entity or through the social media service. This may be accepted by the selection of the offer accept button 408. In the alternative, the counter-offer box 404 may be used by the influencer to request a modification to the terms of the offer if desired; this is submitted back to the business entity for review by selecting the offer modify button 412. Or, the influencer may simply reject the offer by selecting the offer reject button 410.

Once the terms of the engagement have been agreed to, and the program is initiated, the influencer may provide progress data back to the business entity via the follower list box 406, which by selecting the report button 414 enables the submission of the followers that are participating in the program via the influencer. The goal progress bar 416 can provide a visual indicator of the progress that the influencer has made towards the goal of the program.

Other types of controls may be implemented as desired, and other types of reporting data may be provided.

After the major influencer 6 has agreed to terms with the business entity 2 via the dashboard as shown in FIG. 4, the major influencer will then reach out to his/her followers (first level followers 8 as shown in FIG. 3). This may occur in one or more ways as determined by the major influencer 6, including but not limited to the social network service 4 (e.g. FACEBOOK or TWITTER) that is operating the embodiment of this invention. In addition to or in the alternative, the major influencer 6 may utilize other social networking services (e.g. INSTAGRAM, etc.) or even emails or text messages, although it is envisioned that the social network service(s) mentioned above will be the preferred manner of communication to broadcast to all of the followers 8 (which may number in the millions). For example, the major influencer may tweet via TWITTER a message providing to the followers the basic offering and a link to a web page dashboard with further information.

A dashboard may be used to provide control and communications between the major influencer and his followers similar to the one shown in FIG. 4, which modifications made to reflect the data and control implemented at this level. This would contain different terms as determined by the major influencer and/or the business entity 2. The first level followers 8 may then view the terms of the offering, which may be accepted, modified, or rejected, this giving the first level followers 8 a desired amount of user control over the process.

This user control scenario may be repeated down the levels as shown in FIG. 3 to provide all participants with the ability to view program data and provide control over aspects of the program in which they participate, including privacy controls as may be desired that dictate how their profile data may be used.

### Blockchain Utilization

Blockchain is a continuously growing list of records, called blocks, which are linked and secured using cryptography. Each block typically contains a hash pointer as a link to a previous block, a timestamp and transaction data. By design, blockchains are inherently resistant to modification of the data. A blockchain can serve as an open, distributed ledger that can record transactions between two parties efficiently and in a verifiable and permanent way. For use as a distributed ledger, a blockchain is typically managed by a peer-to-peer network collectively adhering to a protocol for validating new blocks. Once recorded, the data in any given block cannot be altered retroactively without the alteration of all subsequent blocks, which requires collusion of the network majority.

In this invention, a blockchain is preferably used to store an ongoing list of records (blocks), each of which stores a user activity that is used to generate the profile and related score. In addition, rewards granted to a member for access to his data may be stored in the blockchain.

A digital wallet is created using a blockchain, which may be carried by a user in a portable device such as a smartphone, smartwatch, and the like. As the user executes a transaction, such as allowing a merchant or other third party to access and utilize their data, that third party may issue micro-bits to that user by adding them to his blockchain ledger on his smartphone. In this manner, the user need not have an account stored at a centralized server computer as in the past, although the third party may optionally keep its own records of the transaction centrally if so desired. As the user earns rewards from the third party for allowing use of his or her data, his or her blockchain will be updated to reflect the additional rewards that have been earned. An application on the smartphone (or other device) may be implemented to enable the blockchain access. This application will also enable the user to determine how many micro-bits he has in his wallet.

At some point, the user may desire to utilize some or all of his micro-bits from his blockchain. A monetization transaction would then take place in which the rewards are deducted from the digital wallet in a subsequent blockchain transaction. The blockchain will keep a running record of all rewards added to the digital wallet as well as those taken from the wallet during the monetization process.

By using the blockchain ledger technology, the requirement for a centralized account is eliminated. Thus, when a consumer allows access to his social network data, the rewards transaction is recorded in the blockchain with requiring a central server. The consumer may then allow another third party to have access to his data, and have a subsequent rewards transaction recorded in his blockchain ledger. Again, this does not require the use of a central server since the blockchain ledger provides the digital wallet functionality.

Additionally, the use of a blockchain methodology in accordance with this invention provides the ability for parties including merchants, issuers, redeemers, and consumers to collaborate with each other without requiring any of the parties to have predetermined relationships established as in the prior art. Because the blockchain ledger is an independent entity and accessible to all parties independently, collaboration as required in the prior art is not required in this invention.

Implementation of the digital wallet with a blockchain ledger provides a carry-forward functionality not found in loyalty systems of the prior art. A consumer may earn rewards at each step of the chain, which are added piece by piece to his blockchain ledger. Different merchants may utilize different rules as desired, and the blockchain ledger will reflect implementation of those rules by the merchants as the user interacts and transacts business with those merchants.

Award and monetization rules may be changed on the fly by each merchant as desired, since the interactions with the blockchain at the point of sale does not require a centralized methodology as in prior art reward systems. These rules may apply to individual consumers, blocks of consumers, all consumers, etc., as may be desired by the merchant. Thus, each reward issuer may tailor its reward program and customize it instantaneously if desired.

By using the decentralized blockchain ledger as a digital wallet, synergies are realized not possible in the prior art. Alliances and coalitions between merchants may be formed, modified, dissolved, etc. in an instantaneous fashion, wherein blockchain rules may be adapted by each merchant along the chain. This provides an agile, modifiable ecosystem for providing and redeeming rewards amongst multiple merchants. Likewise, multiple consumers may be formed into groups by linking their blockchain ledgers without requiring a centralized server. For example, members of a family may form a group that can share rewards amongst them, accumulate them for increased monetization, trade rewards, etc.

By use of the blockchain ledger in the present invention, rewards may be modified in the ledger after they have been awarded. For example, rewards that have been added to a blockchain ledger may be varied as a function of time. Rewards may be reduced in value over time, which may provide an incentive for a consumer to monetize them rather than have them be reduced. This reduction in value need not follow any particular predetermined formula and may be varied in the ledger at will by the merchant that has awarded them. Also, rewards may be varied as a function of volume, whereby changes increase in rewards given by an issuer to its customers may cause the issuer to want to reduce the value of rewards already distributed in order to decrease its overall liability.

The blockchain ledger based reward system described herein thus has great applicability to social networking. Reward-based blockchains may be distributed, modified, adapted etc. by various members of a user's social network, with permissions for ledger access being provided based on social network status. Users may form coalitions to merge and exchange points amongst ledgers of various members within their social network, providing synergies otherwise unattainable in legacy reward systems.

As discussed, scoring methodology is employed that operates on data stored within the blockchain ledger, and which is updated and revised as data in that ledger changes. Sources of data within the blockchain would include the value of transactions, the type of transactions, rewards that are awarded and/or redeemed for a transaction, and the like. The user may have a profile that gives him control over the data utilized in the scoring model, which will alleviate privacy concerns. For example, the user may want to allow the value of a transaction to be used in the scoring model, but not the type of product purchased or the merchant that the product is purchased from. Filters may be applied based on various data types, and the user may modify the profile as desired.

The scoring model may be implemented by an app operating in conjunction with the blockchain, for example residing on the device carrying the blockchain such as a smartphone. The user's score would be stored in the blockchain and accessible via outside parties as allowed by the user. For example, as part of a transaction, a merchant may access the user's score from the blockchain (and/or any supporting data from the blockchain if allowed by the user), which can be used to tailor the transaction to that user in a more beneficial manner. This score may act as a Q rating, similar to what is used to rate celebrities. The score may tie into and/or be based on the user's social network parameters as well.

In addition to user's implementing blockchain for loyalty and other transaction-based parameters, merchants may also implement a blockchain paradigm under this invention. That is, a merchant may carry a blockchain that contains data regarding transaction with customers, rewards that have been awarded, rewards that have been redeemed, etc.

### Data Usage Reporting

In an optional embodiment, data usage reports are generated and provided to the social network members who grant access to their data in exchange for compensation as described above. The reports may be in textual and/or graphical format on a web page, and can reveal how his profile data is being used. This visualization tool may be color coded if desired. Optionally, a sub-score may be generated based on the usage of the profile data, and that sub-score may be made part of the user profile score if desired.

What is claimed is:

1. A method for controlled access to a user profile comprising:
storing a user profile in a computer memory, the user profile comprising data associated with a user;
monitoring computer-based activities of the user on a user computer throughout a defined period of time;
updating the user profile to include each monitored computer-based activity of the user;
for each instance of updating the user profile:
calculating a user profile score as a function of the updated user profile;
providing the user profile score to a third party; and
offering to the third party access to the user's profile in exchange for compensation to the user, only when the user grants permission for the third party to access the user profile.

2. The method of claim 1 wherein the user profile is stored in a blockchain ledger, and wherein the user profile is updated by recording the monitored computer-based activity to a record in the blockchain ledger.

3. The method of claim 2 wherein the compensation comprises rewards that are recorded in the blockchain ledger.

4. The method of claim 3 wherein the rewards comprise micro-bits.

5. The method of claim 2 further comprising the steps of
providing to the user computer a web page dashboard comprising
a list of the computer-based activities stored in the user profile,
a display of the user profile score,
a control that enables the user to specify which computer-based activities are included in the user profile score calculation,
an offer of compensation by the third party to access the user profile, and
a control for the user accept the offer made by the third party to access the user profile.

6. The method of claim 1 wherein
the user is a member of a social network comprising a plurality of members,
each member has a user profile stored in a computer memory that is updated for each computer-based activity;
a network score is calculated as a function of the user profile scores of each member;
the network score is provided to a third party; and
access to each of the member's user profile is offered to the third party in exchange for compensation to the members of the social network, only when the members each grant permission for the third party to access the member's user profile.

7. The method of claim 1 wherein the monitored online activities comprise social network interactions, online purchase transactions, and/or web browsing activities.

8. The method of claim 1 wherein the user profile score varies as a function of a field of use.

9. A system for controlled access to a user profile comprising:
a social network computer comprising
computer memory for storing a user profile, the user profile comprising data associated with a user;
processing means programmed to
monitor computer-based activities of the user throughout a defined period of time;
update the user profile to include each monitored computer-based activity of the user;
for each instance of updating the user profile:
calculate a user profile score as a function of the updated user profile;
provide the user profile score to a third party; and
offering to the third party access to the user's profile in exchange for compensation to the user, only when the user grants permission for the third party to access the user profile.

10. The system of claim 9 wherein the user profile is stored in a blockchain ledger, and wherein the user profile is updated by recording the monitored online activity to a record in the blockchain ledger.

11. The system of claim 10 wherein the compensation comprises rewards that are recorded in the blockchain ledger.

12. The system of claim 11 wherein the rewards comprise micro-bits.

13. The system of claim 10 wherein the processing means of the social network computer is further programmed to
provide to the user computer a web page dashboard comprising
a list of the computer-based activities stored in the user profile,
a display of the user profile score,
a control that enables the user to specify which computer-based activities are included in the user profile score calculation,
an offer of compensation by the third party to access the user profile, and
a control for the user accept the offer made by the third party to access the user profile.

14. The system of claim 10 wherein
the user is a member of a social network comprising a plurality of members,
each member has a user profile stored in a blockchain ledger in the computer memory that is updated for each online activity; and
the processing means is further programmed to
calculate a network score as a function of the user profile scores of each member;
provide the network score to a third party; and
offer to the third party access to each of the member's user profile in exchange for compensation to the members of the social network, only when the members each grant permission for the third party to access the member's user profile.

15. The system of claim 9 wherein the monitored online activities comprise social network interactions, online purchase transactions, and/or web browsing activities.

16. The system of claim 9 wherein the user profile score varies as a function of a field of use.
